(19) United States
(12) Patent Application Publication
(10) Pub. No.: US 2007/0017655 A1
(43) Pub. Date: Jan. 25, 2007

(54) Temperature control unit in air-conditioning system

(75) Inventors: Toshikatsu Mouri, Saitama (JP); Michihito Sato, Saitama (JP); Hisayoshi Yoshizaki, Saitama (JP)

Correspondence Address: RADER FISHMAN & GRAUER PLLC, LION BUILDING, 1233 20TH STREET N.W., SUITE 501, WASHINGTON, DC, 20036, US

(73) Assignee: Valeo Thermal Systems Japan Corporation, Saitama (JP)

(21) Appl. No.: 11/488,023

(22) Filed: Jul. 18, 2006

(30) Foreign Application Priority Data
Jul. 21, 2005 (JP) JP2005-211175

(51) Int. Cl. B60H 3/00

(52) U.S. Cl. 165/42; 165/203

(57) ABSTRACT

Object of this invention is to allow baffle plates with varying functions to be interchangeably mounted at a single air-conditioning system and to prevent an erroneously selected baffle plate from being mounted undetected. A unit case 3 includes a plurality of fastening structures 24 and 25 as required, each to be used in conjunction with one of the baffle plates 20A, 20B and 20C with differing functions. The baffle plates 20A, 20B and 20C each include a fastening structure that is used in conjunction with the fastening structure 24 or 25 at the unit case 3 or is used by itself when mounting the corresponding baffle plate 20A, 20B or 20C at the unit case 3.

### CROSS-REFERENCE TO RELATED APPLICATIONS

This application is based upon and claims the benefit of priority from the prior Japanese Patent Application No. 2005-211175, filed on Jul. 21, 2005, the entire contents of which are incorporated herein by reference.

### TECHNICAL FIELD

The present invention relates to a structure that may be adopted in an automotive air-conditioning system at which baffle plates with various functions can be interchangeably mounted at a position where two air flow paths join each other and more specifically, it relates to a structure that may be adopted in the temperature control unit in such an air-conditioning system.

### BACKGROUND ART

A semi-integrated automotive air-conditioning system comprising a blower unit and a temperature control unit may adopt a structure that includes a temperature control guide means constituted with a baffle plate or the like disposed at a position where a cool air flow path through which cool air having passed through a cooling heat exchanger and having bypassed a heating heat exchanger flows and a warm air passage through which warm air having passed through the heating heat exchanger flows, join each other as has been disclosed by the applicant of the present invention (see, for instance, patent reference literature 1 and patent reference literature 2).
(patent reference literature 1) Japanese Unexamined Patent Publication No. 2002-274149
(patent reference literature 2) Japanese Unexamined Patent Publication No. 2005-104250

### DISCLOSURE OF THE INVENTION

### Problems to be Solved by the Invention

When a temperature control unit adopting a specific basic structure is used as a universal component in different types of vehicles assuming slightly different installation layouts of the air-conditioning ducts to be connected to the output openings of the temperature control unit 1 or slightly different positions at which the output port at the front end of each air-conditioning duct opens into the cabin, the slight differences in the installation layout or the opening position may affect the temperature of the air being output. In addition, air-conditioning systems installed in vehicles for overseas markets will be used in operating environments completely different from that in Japan.

In other words, air-conditioning systems need to be versatile enough to meet varying requirements, e.g., a relatively low defrost (DEF) output air temperature to be achieved in a DEF/HEAT (D/H) mode and a significant temperature difference to be achieved between the vent (VENT) output air temperature and the foot (FOOT) output air temperature in a bi-level (B/L) mode.

While such versatility may be assured by mounting interchangeable baffle plates with varying functions, different baffle plates may need to be fastened at the air-conditioning unit through different structures and, in such a case, only one type of baffle plates may be compatible with a specific type of air-conditioning system. This leads to a concern that the structure assumed in the air-conditioning system case may need to be altered in correspondence to the baffle plate to be used or that the temperature control performance initially achieved in the air-conditioning system may be compromised.

Furthermore, if baffle plates with different functions can be mounted at the air-conditioning system through identical fastening structures, a baffle plate erroneously selected may be mounted without being detected and the erroneous assembly of the air-conditioning system may thus remain uncorrected.

Accordingly, an object of the present invention is to provide a temperature control unit in an air-conditioning system, which allows baffle plates with different functions to be interchangeably mounted at the same air-conditioning system and prevents the wrong baffle plate from being mounted.

### Means for Solving the Problems

The temperature control unit in an air-conditioning system according to the present invention comprises a cooling heat exchanger and a heating heat exchanger housed within an air flow path defined inside a unit case with the cooling heat exchanger disposed on the upstream side. The air flow path is constituted with a cool air flow path through which air having bypassed the heating heat exchanger flows and a warm air passage through which air having passed through the heating heat exchanger flows, with the cool air flow path and the warm air passage made to join each other at a specific area. Over an area of the unit case further toward the downstream side relative to the joining area, a VENT output opening, a DEF output opening and a FOOT output opening are formed, and a baffle plate that guides the warm air having traveled through the warm air passage toward the VENT output opening and guides the cool air having traveled through the cool air flow path along a direction intersecting the flow of the warm air is disposed over the joining area. The baffle plate is one of interchangeable baffle plates with different functions that are members independent of the unit case and can be interchangeably mounted at the unit case. The individual baffle plates assume fastening structures different from one another, and the unit case includes a plurality of fastening structures each corresponding to a fastening structure of one of the baffle plates and each assuming a specific position or mode so as to ensure that when the baffle plate is mounted, the fastening structures for the other baffle plates in an idle state do not impinge on its operation.

More specifically, a first fastening structure among the plurality of fastening structures adopted at the unit case is achieved by forming a plurality of recessed portions at the inner side surface of the unit case and a fastening structure adopted at a first baffle plate among the baffle plates having the various functions is achieved by forming projections on its side extending along the flow of warm air, which can be fitted at the recessed portions. In addition, a second fastening structure among the plurality of fastening structures adopted at the unit case is achieved by forming a projected portion projecting into the air flow path from the inner side surface of the unit case and a fastening structure adopted at a second baffle plate among the baffle plates having the various functions is achieved by forming on the side thereof extending along the flow of the warm air a hole to fit around the outside of the projected portion at the unit case with the projected portion at the unit case disposed so as to be set further outward relative to the outer edge of the side of the baffle plate when the second baffle plate is mounted. A fastening structure adopted at a third baffle plate among the baffle plates having the various functions includes a holding portion with which an end of one of internal walls defining the air flow paths can be held. It is to be noted that the fastening structure adopted at the third baffle plate among the baffle plates having the various functions may include a flange portion located on the side opposite from the side where the holding portion is present, which can be set at the upper surface of another internal wall. Although not shown, a fastening structure that includes a groove extending at the inner surface of the unit case along the direction in which the baffle plate is inserted may be adopted at the unit case and a fastening structure that includes a rib to be inserted at the groove may be adopted at the baffle plate instead.

### Effect of the Invention

Thus, while the output port positions, the air-conditioning duct installation layout, the required air output quantities or the like may vary for different vehicle models or for the overseas specifications and the domestic market specifications of a given vehicle model, different baffle plates with various functions each corresponding to a specific requirement can be interchangeably mounted at the temperature control unit of an air-conditioning unit so as to allow the air-conditioning system to be used as a universal system according to the present invention. As a result, the temperatures and the air volumes of the VENT output air and the FOOT output air can be adjusted so as to meet the requirements of different users. This eliminates the need for altering the structure of the unit case of the air-conditioning system in correspondence to the type of baffle plate to be used and thus, ultimately eliminates the problem of loss of the temperature control performance initially achieved in the air-conditioning system. In addition, the temperature range, i.e., the difference between the highest temperature and the lowest temperature in an intermediate mode such as the B/L mode or the D/H mode can be adjusted by switching baffle plates.

Furthermore, according to the present invention, each fastening structure with specific features is disposed at a position at which it does not get in the way when another baffle plate is mounted. Since the various baffle plates need to be mounted differently from one another and thus an erroneous selection of baffle plate to be used can be detected with ease, the wrong baffle plate is never actually mounted.

### BRIEF DESCRIPTION OF THE DRAWINGS

FIG. 1 is a sectional view schematically showing the structure of the temperature control unit in an air-conditioning system adopting the present invention with no baffle plate mounted thereat;

FIG. 2 is an enlarged view of the fastening structures included at the unit case of the temperature control unit in FIG. 1, via which baffle plates are mounted;

FIG. 3 is an assembly diagram showing one of baffle plates with varying functions mounted at the split unit case;

FIG. 4 is an enlargement of the assembly diagram in FIG. 3, taken from the opposite sides along the left/right direction;

FIG. 5 is an enlargement of the assembly diagram in FIG. 3, taken from above;

FIG. 6 presents a characteristics diagram of changes occurring in the FOOT output air average temperature and the VENT output air average temperature in the B/L mode in the temperature control unit mounted with the baffle plate shown in FIG. 3 and the like as the degree of openness of the mix door changes;

FIG. 7 presents a characteristics diagram of changes occurring in the FOOT output air average temperature, the DEF output air average temperature and the VENT output air average temperature in the D/H output mode in the temperature control unit mounted with the baffle plate in FIG. 3 and the like as the degree of openness of the mix door changes;

FIG. 8 is an assembly diagram showing a baffle plate other than that shown in FIG. 3 among the baffle plates with varying functions mounted at the split unit case;

FIG. 9 is an enlargement of the assembly diagram in FIG. 8, taken from the opposite sides along the left/right direction;

FIG. 10 is an enlargement of the assembly diagram in FIG. 8 taken from above;

FIG. 11 presents a characteristics diagram of changes occurring in the FOOT output air average temperature and the VENT output air average temperature in the B/L mode in the temperature control unit mounted with the baffle plate shown in FIG. 8 and the like as the degree of openness of the mix door changes;

FIG. 12 presents a characteristics diagram of changes occurring in the FOOT output air average temperature, the DEF output air average temperature and the VENT output air average temperature in the D/H output mode in the temperature control unit mounted with the baffle plate in FIG. 8 and the like as the degree of openness of the mix door changes;

FIG. 13 is an assembly diagram showing a baffle plate other than that shown in FIG. 3 and the like or that shown in FIG. 8 and the like among the baffle plates with varying functions mounted at the split unit case;

FIG. 14 illustrates how the baffle plates with varying functions can be interchangeably mounted at a single temperature control unit.

### EXPLANATION OF REFERENCE NUMERALS

1 temperature control unit
3 unit case
4 cooling heat exchanger
5 heating heat exchanger
7 warm air passage
8 cool air flow path
9 air mix chamber (joining area)
11 DEF opening
12 VENT opening
13 air guide internal wall (internal wall)
15 FOOT opening
19 air guide internal wall (internal wall)
20A baffle plate
20B baffle plate
20C baffle plate
24 unit case fastening structure (first fastening structure)
25 unit case fastening structure (second fastening structure)
26 fastening structure at baffle plate 20A
27 fastening structure at baffle plate 20B
28 fastening structure at baffle plate 20C
30 recessed portion
31 recessed portion
32 recessed portion
33 projection
34 projection
35 projection
36 projected portion
37 projected portion
38 through hole (hole)
39 through hole (hole)
40 holding portion
41 flange portion

### BEST MODE FOR CARRYING OUT THE INVENTION

The following is an explanation of an embodiment of the present invention, given in reference to the drawings.

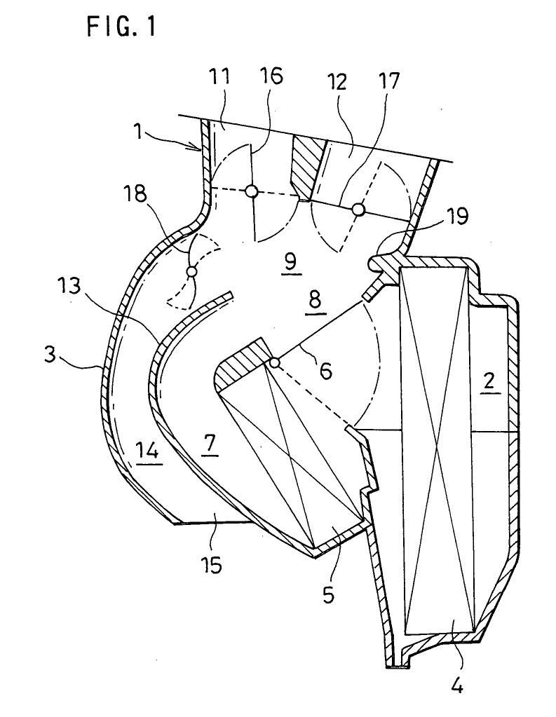

FIG. 1 schematically shows a structural example that may be adopted in a temperature control unit 1 of an air-conditioning system, at which none of the baffle plates to be detailed later is mounted yet. The temperature control unit 1 is linked with a blower unit (not shown) that includes at least inside/outside air intake ports, an inside/outside air switching door and an air blower so as to constitute a semi-integrated, vertical-installation air-conditioning system installed in the center console area of a vehicle.

In the temperature control unit 1, a cooling heat exchanger 4 such as an evaporator that cools air supplied from the air blower via an air intake port (not shown) opening on the upstream side of the temperature control unit 1, a heating heat exchanger 5 such as a heater core that reheats the air having been cooled at the cooling heat exchanger 4 and a mix door (MIXDOOR) 6 disposed between the cooling heat exchanger 4 and the heating heat exchanger 5 to adjust the ratio of air to be supplied to the heating heat exchanger 5 and air to bypass the heating heat exchanger 5 are all disposed along an air flow path 2 formed inside a unit case 3.

The cooling heat exchanger 4 installed upright so that all the air guided through the air flow path 2 passes through it may include, for instance, corrugated fins and tubes alternately layered over a plurality of stages with tanks installed at the ends of the longer side of the tubes. It is connected as necessary with other air-conditioning devices (not shown) via a piping or the like so as to constitute a refrigerating cycle.

The temperature control unit 1 includes a warm air passage 7 formed inside the unit case 3 further toward the downstream side relative to the heating heat exchanger 5 and constituting part of the air flow path 2, through which the air having been reheated at the heating heat exchanger 5 passes and a cool air flow path 8 disposed so as to range from the downstream side of the cooling heat exchanger 4 toward the upper area slightly diagonal relative to the rotating shaft of the mix door 6 and constituting part of the air flow path 2. In order to provide the temperature control unit 1 as a compact unit, the heating heat exchanger 5 in the embodiment is disposed by tilting its head forward along the vehicle advancing direction and assumes a structure that includes, for instance, corrugated fins and tubes alternately layered over a plurality of stages with tanks mounted at the ends of the longer side of the tubes. The mix door 6 in the embodiment adopts the so-called flag structure or cantilever structure. The mix door 6 comprises the rotating shaft disposed toward the top of the heating heat exchanger 5 and a door main body ranging from the rotating shaft toward one side along the radial direction.

The air flow path 2 includes an air mix chamber 9 where the warm air passage 7 and the cool air flow path 8 join each other and a DEF opening 11 and a VENT opening 12 are formed at the upper surface of the unit case 3 on the downstream side of the air mix chamber 9. At the VENT opening 12, an air guide internal wall 19 ranging from the vicinity of the air mix chamber 9 to the open end of the VENT opening 12 is formed. The DEF opening 11 and the VENT opening 12 each communicate with an output port opening into the cabin via ducts (not shown), with a mode switching doors 16 and 17 for adjusting the degrees of openness of the individual openings 11 and 12 from the fully open state to the fully closed state disposed respectively near the open ends of the DEF opening 11 and the VENT opening inside the air flow path 2. The output mode switching doors 16 and 17 in the embodiment are butterfly-type doors.

Another air guide internal wall 13 is formed on the downstream side of the heating heat exchanger 5. The air guide internal wall 13 functions as a partition that ranges in the front/rear direction along the vehicle body to partition the warm air passage 7 from a Foot passage 14 and also guides the temperature-controlled air to a FOOT opening 15 that opens as required at the bottom surface of the unit case 3. An output mode switching door 18 through which the volume of the temperature-controlled air to be guided to the FOOT opening 15 is adjusted between the 100% through 0% range is disposed inside the Foot passage 14. The output mode switching door 18 also adopts a butterfly structure in the embodiment.

Air taken into the blower unit via the air blower in the air-conditioning system adopting the structure described above is guided to the temperature control unit 1 via an air intake port, travels to the upstream side of the cooling heat exchanger 4 and becomes cooled as it passes through the cooling heat exchanger 4. The ratio of air to pass through the heating heat exchanger 5 and the air to bypass the heating heat exchanger 5 is adjusted in correspondence to the degree of openness of the mix door 6, and after the air having passed through the heating heat exchanger and the air having bypassed the heating heat exchanger are mixed at the air mix chamber 9 located on the downwind side of the mix door 6, the mixed air is output through a specific output port via the DEF opening 11, the VENT opening 12 or the FOOT opening 15 opened as per the selected output mode.

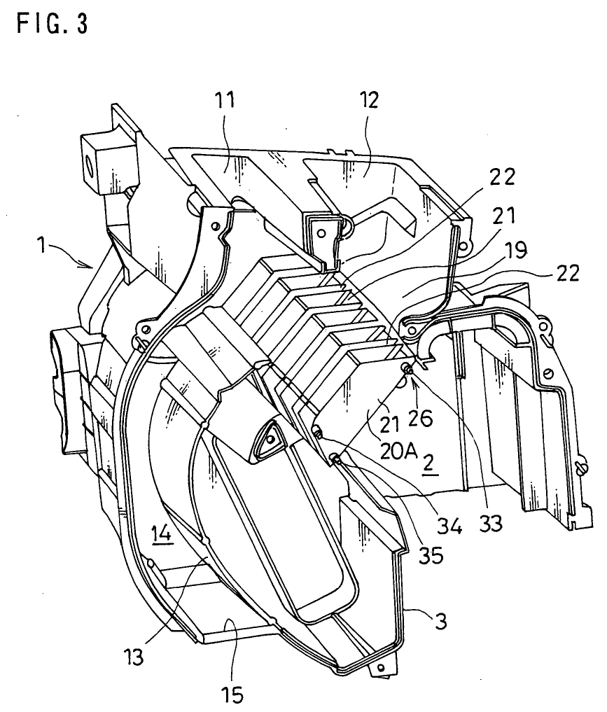

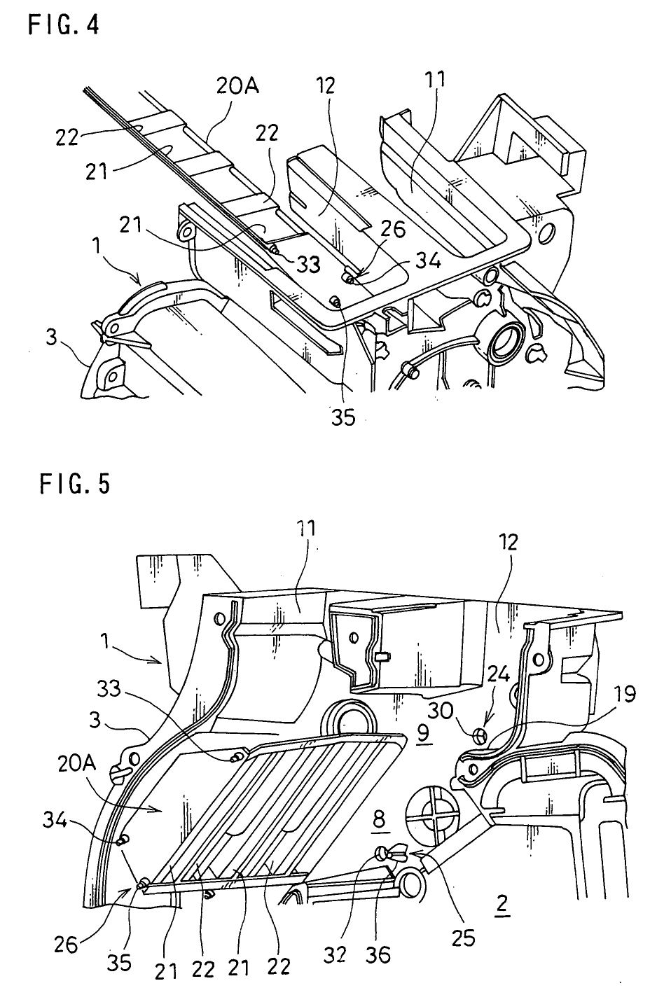

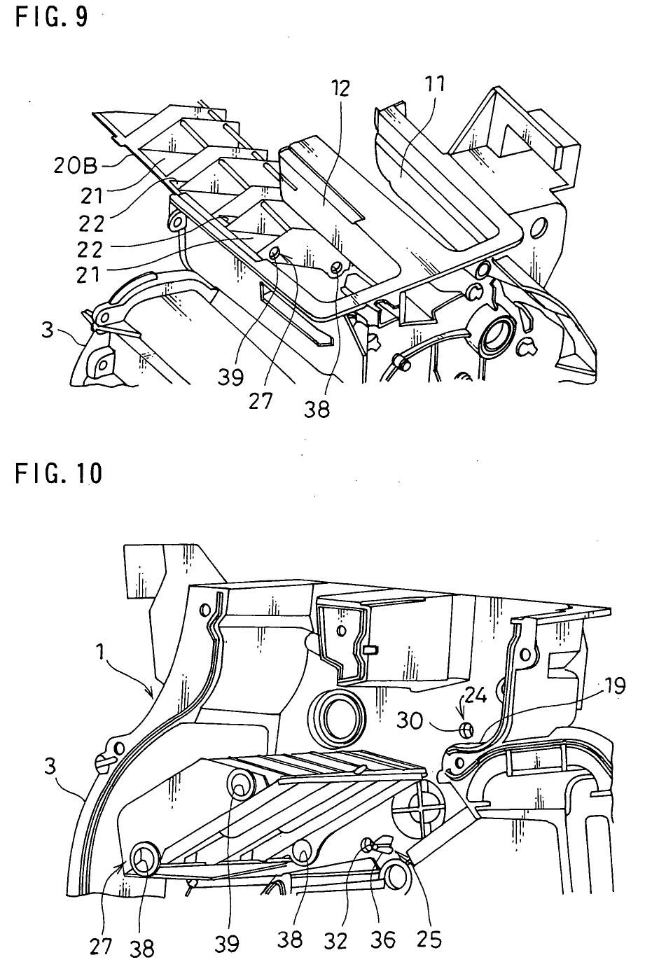

As shown in FIGS. 3 through 9, a baffle plate 20A, 20B or 20C is interchangeably mounted in the air mix chamber 9 according to the present invention. The baffle plate 20A, 20B or 20C is a member independent of the unit case 3 of the temperature control unit 1, is mounted from the open side of the unit case 3 split along the direction running along the width of the vehicle, as shown in FIGS. 3, 7 and 11.

As shown in FIGS. 3, 4 and 5, the baffle plate 20A is formed by alternately disposing a warm air guide portion 21, which is constituted with a guide plate and side portions extending from the side edges of the guide plate and assumes a substantially U-shape with an open top, and a cool air guide portion 22, which includes a continuous connector portion disposed between the warm air guide portion 21 and the next warm air guide portion 21 to continuously connect the warm air guide portions 21 and 21, and constitutes a blow-by defined by the continuous connector portion and the sides of the warm air guide portions. Thus, in a structure in which the warm air having passed through the warm air passage 7 and the cool air having traveled through the cool air flow path 8 cross each other, the flow of the warm air guided by the warm air guide portions 21 is not blocked by the cool air having traveled through the cool air flow path 8 so that the warm air can be supplied into the VENT opening 12 as desired. At the same time, the cool air having traveled through the cool air flow path 8 is guided through the cool air guide portions 22 and thus, the flow of cool air toward the downstream side is not readily blocked by the baffle plate 20B.

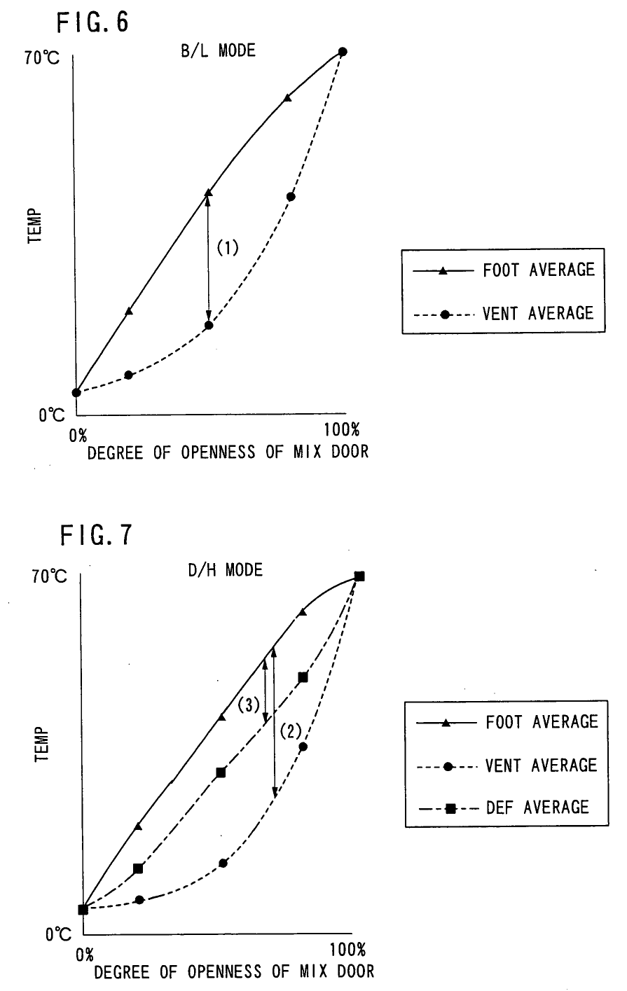

The temperature control unit mounted with the baffle plate 20A demonstrates characteristics such as those shown in FIGS. 6 and 7 with regard to the average temperature of the output air. Namely, as shown in FIG. 6, a relatively large difference manifests between the temperature increase rate of the foot (FOOT) output air average temperature and the temperature increase rate of the vent (VENT) output air average temperature as the degree of openness of the mix door gradually increases from 0% up to approximately 50% with a maximum temperature difference (1) of approximately 25° C. in the B/L mode. Once the degree of openness of the mix door exceeds 50%, the increase rate of the VENT output air average temperature, too, shows a relative rise, and when the degree of openness of the mix door is at 100%, the FOOT output air average temperature and the VENT output air average temperature become substantially equal to each other at 70° C.

In the D/H mode, a relatively large difference manifests between the temperature increase rate of the foot (FOOT) output air average temperature and the temperature increase rate of the vent (VENT) output air average temperature over the range of the degree of openness of the mix door from 0% up to approximately 70%, with a maximum temperature difference (2) of approximately 25° C. manifesting when the degree of openness of the mix door is approximately 50°, as shown in FIG. 7. In addition, a relatively large difference manifests between the temperature increase rate of the foot (FOOT) output air average temperature and temperature increase rate of the defrost (DEF) output air average temperature over the range of the degree of openness of the mix door from 0% up to approximately 70%, with a maximum temperature difference (3) of approximately 12° C. manifesting when the degree of openness of the mix door is approximately 50°. It is to be noted that once the degree of openness of the mix door exceeds 70%, the increase rate of the DEF output air average temperature and the VENT output air average temperature both demonstrate a relative and gradual increase, resulting in a reduction in the temperature difference and when the degree of openness of the mix door is at 100%, the FOOT output air average temperature, the DEF output air average temperature and the VENT output air average temperature all become substantially equal to one another at 70° C.

Thus, by mounting the baffle plate 20A, the need to achieve a relatively large temperature difference between the vent (VENT) output air temperature and the foot (FOOT) output air temperature in the bi-level (B/L) mode is satisfied, as shown in FIG. 6.

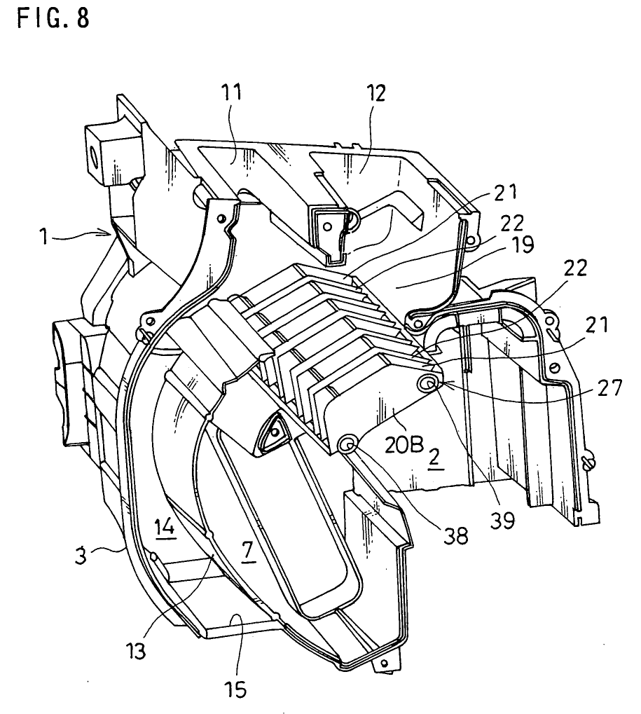

As shown in FIGS. 8, 9 and 10, the baffle plate 20B, too, is formed by alternately disposing a warm air guide portion 21, which is constituted with a guide plate and side portions extending from the side edges of the guide plate and assumes a substantially U-shape with an open top, and a cool air guide portion 22 that includes a continuous connector portion disposed between the warm air guide portion 21 and the next warm air guide portion 21 to continuously connect the warm air guide portions 21 and 21 and constitutes a blow-by defined by the continuous connector portion and the sides of the warm air guide portions. The baffle plate 20B thus achieves an advantage similar to that of the baffle plate 20A in that the warm air can be guided to the VENT opening 12 in an optimal flow without blocking the flow of the cool air. However, the guide plate at the warm air guide portion 21 in the baffle plate 20B is set at a gentler tilt relative to the angle of inclination of the warm air guide portions 21 in the baffle plate 20A and, for this reason, the baffle plate 20B achieves functions different from those of the baffle plate 20A with regard to the direction/speed of the warm air having passed through the warm air guide portions 21 flows.

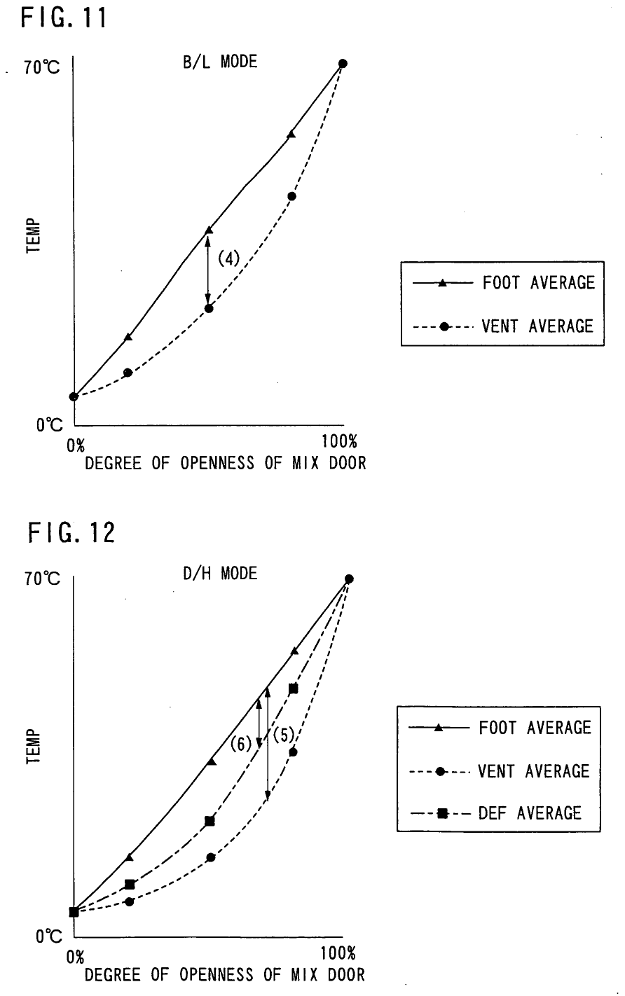

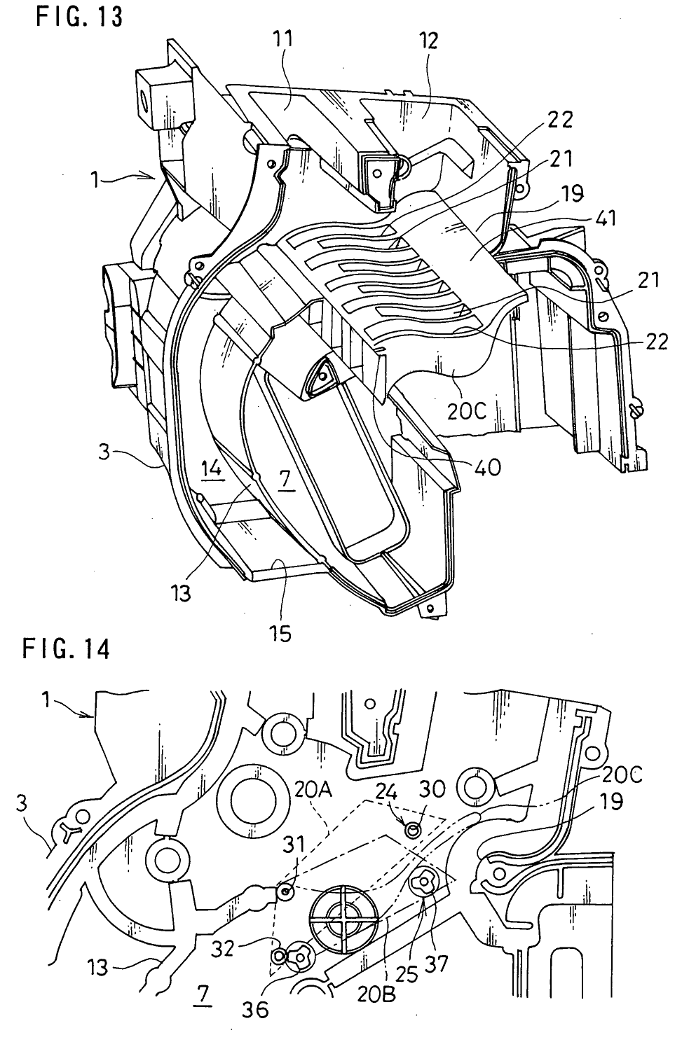

The temperature control unit mounted with the baffle plate 20B demonstrates characteristics such as those shown in FIGS. 11 and 12 with regard to the average temperature of the output air. The foot (FOOT) output air average temperature and the vent (VENT) output air average temperature are controlled in the B/L mode so as to maintain a relatively small difference between the foot temperature increase rate and the vent temperature increase rate over the entire range of the degree of openness of the mix door, as shown in FIG. 11, with a maximum temperature difference (4), measured when the degree of openness of the mix door is approximately 50°, kept down at approximately 15° C. Once the degree of openness of the mix door exceeds 50%, the temperature difference between the FOOT output air average temperature and the VENT output air average temperature further decreases and when the degree of openness of the mix door is at 100%, the FOOT output air average temperature and the VENT output air average temperature become substantially equal to each other at 70° C. in the temperature control unit mounted with the baffle plate 20B.

The foot (FOOT) output air average temperature and the vent (VENT) output air average temperature are controlled in the D/H mode so as to maintain a relatively small difference between the foot temperature increase rate and the vent temperature increase rate over the entire range of the degree of openness of the mix door, as shown in FIG. 12, with a maximum temperature difference (5), measured when the degree of openness of the mix door is approximately 70°, kept down at approximately 20° C. In addition, the foot (FOOT) output air average temperature and the vent (VENT) output air average temperature are controlled in the D/H mode so as to maintain a relatively small difference between the foot temperature increase rate and the defrost temperature increase rate over the entire range of the degree of openness of the mix door, with a maximum temperature difference (6) measured when the degree of openness of the mix door is approximately 70°, kept down at approximately 10° C. Once the degree of openness of the mix door exceeds 50%, temperature differences among the FOOT output air average temperature, the DEF output air average temperature and the VENT output air average temperature are further reduced and when the degree of openness of the mix door is at 100%, the FOOT output air average temperature, the DEF output air average temperature and the VENT output air average temperature become substantially equal to one another at 70° C. in the temperature control unit mounted with the baffle plate 20B.

The need for keeping the DEF output air temperature at a relatively low level in the DEF/HEAT (D/H) mode compared to the level of the DEF output air temperature achieved by mounting, for instance, the baffle plate 20A is thus satisfied by installing the baffle plate 20B, as the DEF output air average temperature in FIG. 12 is relatively low over the entire range of the degree of openness of the mix door compared to the DEF output air average temperature in FIG. 7.

As shown in FIG. 13, the baffle plate 20C in the embodiment includes warm air guide portions 21 and cool air guide portions 22 layered alternately to each other. The baffle plate 20C is characterized in that the cool air guide portions 22 have their upstream ends along the lengthwise direction blocked off with walls so as not to prevent any warm air from flowing into them and that the cool air guide portions 22 each include a side extending further outward along the width of the vehicle. The warm air guide portions 21, each assuming a wavy shape with a guide plate tilting upward from the upstream side toward the downstream side and having an upper plate portion facing opposite the guide plate and slightly distending outward from the upstream side, thereby achieving a large opening area at the opening formed toward the VENT opening 12. The baffle plate 20C adopting the structure described above achieves functions different from those of the baffle plate 20A or the baffle plate 20B with regard to the direction/speed of the warm air having passed through the warm air guide portions 21 flows.

The unit case 3 in the embodiment includes two fastening structures 24 and 25 to allow any of the baffle plates 20 (20A, 20B, 20C) structured as described above to be mounted at the unit case 3. The baffle plate 20A includes a fastening structure 26 to be used in conjunction with the fastening structure 24, the baffle plate 20B includes a fastening structure 27 to be used in conjunction with the fastening structure 25 and the baffle plate 20C includes a fastening structure 28 that allows the baffle plate 20C to be mounted at the unit case 3 without requiring any corresponding fastening structure at the unit case 3.

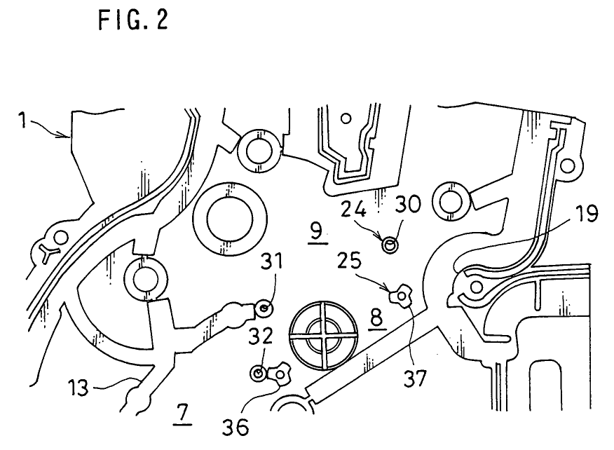

Namely, as shown in FIGS. 2 and 5, the fastening structure 24 at the unit case 3 includes three recessed portions 30, 31 and 32 formed at an inner side surface defining the air mix chamber 9 and each assuming the shape of a bottomed hole, whereas the fastening structure 26 at the baffle plate 20A includes projections 33, 34 and 35 projecting out from the side of the outermost warm air guide portion 21 toward the side opposite from the side where the cool air guide portions 22 are present, as shown in FIGS. 3 through 5. The projection 33, the projection 34 and the projection 35 are formed so as to fit in the recessed portions 30, 31 and 32 respectively.

In addition, the fastening structure 25 at the unit case 3 includes two projected portions 36 and 37 formed at the inner side surface defining the air mix chamber 9, as shown in FIG. 2, whereas the fastening structure 27 at the baffle plate 20B includes through holes 38 and 39 formed at the side of the outermost warm air guide portion 21, as shown in FIGS. 8 through 10. The projected portions 36 and 37 are formed so as to fit in the through hole 38 and the through hole 39 respectively.

The fastening structure 28 at the baffle plate 20C includes a holding portion 40 with a two-pronged end so as to hold the downstream-side end of the air guide internal wall 13 and a flange portion 41 that can be set at the upper surface of the air guide internal wall 19.

The projected portions 36 and 37 constituting the fastening structure 25 at the unit case 3 are disposed further toward the bottom of the vehicle relative to the outer edge of the side of the baffle plate 20A and the outer edge of the side of the baffle plate 20C and thus, the projected portions 36 and 37 in an idle state do not get in the way when the baffle plate 20A or the baffle plate 20C is mounted. It is to be noted that since the fastening structure 24 at the unit case 3 constituted with the recessed portions 30, 31 and 32 does not include any portion projecting out from the wall surface, the fastening structure 24 does not become an obstruction when the baffle plate 20B or the baffle plate 20C is mounted.

As described above, the baffle plates 20A, 20B and 20C with different structures and functions can be interchangeably mounted at a single temperature control unit 1. Thus, the baffle plate 20A, 20B or 20C can be selectively mounted to achieve specific air-conditioning performance characteristics to assure a high level of versatility in the performance of the temperature control unit 1. In other words, by selecting one of the baffle plates 20A, 20B and 20C, the temperature range, i.e., the difference between the highest temperature and the lowest temperature achieved in an intermediate mode such as the B/L mode or the D/H mode can be adjusted to satisfy specific performance requirements.

In addition, even if the baffle plate 20A is the correct baffle plate for the particular requirements to be satisfied and the wrong baffle plate 20B is erroneously selected, the assembly worker is bound to notice the mistake since the baffle plate 20B must be mounted via fastening structures different from those for the baffle plate 20A. Thus, erroneous baffle plate assembly can be avoided.

1. A temperature control unit in an air-conditioning system comprising a cooling heat exchanger and a heating heat exchanger housed within an air flow path defined inside a unit case with said cooling heat exchanger disposed on the upstream side, said air flow path constituted with a cool air flow path through which air having bypassed said heating heat exchanger flows, with a warm air passage through which air having passed through said heating heat exchanger flows, with said cool air flow path and said warm air passage made to join each other at a specific area and a VENT output opening, a DEF output opening and a FOOT output opening formed to open at said unit case over an area further downstream relative to said joining area,
wherein a baffle plate, which guides warm air having traveled through said warm air passage toward said VENT output opening and guides cool air having traveled through said cool air flow path along a direction intersecting the flow of the warm air, is disposed over said joining area; and
wherein said baffle plate is one of interchangeable baffle plates with different functions that are members independent of said unit case and can be interchangeably mounted at said unit case, the individual baffle plates assume fastening structures different from one another, and said unit case includes a plurality of fastening structures each corresponding to a fastening structure of one of said baffle plates and each assuming a specific position or mode so as to ensure that when said baffle plate is mounted, said fastening structures for the other baffle plates in an idle state do not obstruct said baffle plate.

2. A temperature control unit in an air-conditioning system according to claim 1,
wherein a first fastening structure among said plurality of fastening structures adopted at said unit case is achieved by forming a plurality of recessed portions at the inner side surface of said unit case and a fastening structure adopted at a first baffle plate among said baffle plates having the various functions is achieved by forming projections on a side thereof extending along the flow of warm air, which can be fitted at the recessed portions.

3. A temperature control unit in an air-conditioning system according to claim 1, characterized in:
wherein a second fastening structure among said plurality of fastening structures adopted at said unit case is achieved by forming a projected portion projecting into said air flow path from the inner side surface of said unit case and a fastening structure adopted at a second baffle plate among said baffle plates having the various functions is achieved by forming at a warm air a hole to fit around the outside of said projected portion at said unit case with said projected portion at said unit case disposed so as to be set further outward relative to the outer edge of the side of said second baffle plate when said second baffle plate is mounted.

4. A temperature control unit in an air-conditioning system according to claim 1, characterized in:
wherein a fastening structure adopted at a third baffle plate among said baffle plates having the various functions includes a holding portion with which an end of one of internal walls defining the air flow paths can be held.

5. A temperature control unit in an air-conditioning system according to claim 4, characterized in:
wherein said fastening structure adopted at said third baffle plate among said baffle plates having the various functions includes a flange portion located on the side opposite from the side where said holding portion is present, which can be set at the upper surface of another internal wall.
